(19) United States
(12) Patent Application Publication
(10) Pub. No.: US 2015/0189823 A1
(43) Pub. Date: Jul. 9, 2015

(54) DIGGING TOOL

(71) Applicant: Curran Page Hauger, Norfolk, VA (US)

(72) Inventor: Curran Page Hauger, Norfolk, VA (US)

(21) Appl. No.: 14/150,369

(22) Filed: Jan. 8, 2014

(51) Int. Cl. A01B 1/08; A01B 1/14

(52) U.S. Cl. CPC A01B 1/08; A01B 1/14

(57) ABSTRACT

A digging tool having a short handle and downwardly depending blade that can be placed on the ground. A striking (i.e., force receiving) surface is provided and configured to be struck by a hammer in order to drive the downwardly depending blade into the soil. Once driven into the soil, the user can simply lift up the handle to break the soil, and pull the soil out of the way. The tool may then be moved to the next location and the striking, pulling moving sequence of operation may be repeated. The tool is particularly useful in locations with limited overhead clearance. In such spaces, conventional tools of the prior art are typically unable to be raised over a user's head and then swung downward with sufficient force to accomplished a desired digging task.

### RELATED APPLICATIONS

This application claims priority in accordance with 37 C.F.R. ¶1.19(e) to U.S. Provisional Patent Application Ser. No. 61/754,112 filed Jan. 18, 2013 for HITMAN GRUB HOE which is included herein in its entirety by reference.

### FIELD OF THE INVENTION

The invention pertains to digging tools and, more particularly, to a short handle digging tool adapted to be driven into the earth by a hammer.

### BACKGROUND OF THE INVENTION

Many tools for digging in the earth are known and have been known since prehistoric times. Shovels, picks, hoes, and the like exist in a multitude of different sizes, shapes, colors, etc. One particular class of tools includes members such as grub hoes, pick mattocks, etc. are tools having a blade designed to penetrate the earth. Typically such tools have long handles. A user raises the tool high above the ground and brings it forcefully down onto a selected point on the earth. The effectivity of the tool depends on the mass of the tool, the velocity with which the user can cause the tool to impact the earth, and the precision with which the user is able to strike the desired point on the earth.

However, when attempts to use such tools in confined spaces, particularly in spaces having limited vertical clearance, such tools are hopelessly inadequate for digging. A long handled tool just can't be raised high enough to impart enough force to impact the ground effectively. For example, a user needing to dig a trench in a crawl space under a house is left with few tools suitable for the task.

It would be desirable to have a digging tool that does not rely on a forceful downward impact from that same tool raised high above the ground.

### DISCUSSION OF THE RELATED ART

Several attempts to provide a digging tool that may be hammer driven and suitable for use in spaces with limited overhead clearance may be found in the prior art. For example, U.S. Pat. No. 8,146,460 for NAIL RIPPER, issued Apr. 3, 2012 to Craig Elliott discloses a tool for lifting building materials, such as shingles, while extracting nails that fastened those materials. The slots that grip the nails are a concatenation of overlapping holes, for smooth insertion of the tool past the nails, and the envelope of the tool is a surface of curves for smooth insertion of the tool under the building materials. The bottom surface is a rocker that provides a moving fulcrum for prying out the nail, giving maximum force when the nail is first gripped and smoothly moving to maximum speed of extraction as the fulcrum moves back towards the user. Specifically, the tool may have projecting horns 19 for receiving hammer impacts. (column 6, lines 44-52).

U.S. Pat. No. 6,485,076 for VERSATILE ATTACHMENT FOR A SHOVEL, issued Nov. 26, 2002 to William Nai-Jen Chang, shows a versatile attachment in the form of an elongated member having an obtuse angle mounted on a shovel handle. The lower end of the elongated member is pivotally mounted in a cantilever manner to the lower portion of the shovel handle. The elongated member mounted with the obtuse angle portion of the elongated member located selectively either above or below the longitudinal axis of the shovel handle. A cross bar member is provided at the upper free end of the elongated member and a rotary wheel is rotatably mounted on the cross bar member. A strap is provided at the shovel handle and is operative for securing the attachment to the latter. Specifically, a crossbar 19 (best seen in FIG. 1) may be struck by foot to provide blow force for a shovel blade (column 4, lines 1-15).

U.S. Pat. No. 4,458,415 for HAMMER DRIVEN CHOPPER, issued Jul. 10, 1984 to Eugene Maher et al., teaches a chopping hand tool, including a slidable hammer along a handle of the tool for striking against a hammer stop mounted on the handle, so to transmit the hammer striking force to a toothed edge of a blade affixed to one end of the handle, so that the toothed edge is used to chip materials against which it is applied.

United States Published Patent Application No. 2008/0295254 or DEMOLITION TOOL BAR, published Dec. 4, 2008 upon application by James Meekins, shows an improved construction pry bar is presented that possesses unique features. The pry bar has a cutting slot in its leading edge that can slice through or grip and remove nails from construction materials. The pry bar head also possesses two flat shoulders that make it possible to drive the pry bar between two pieces of construction material by means of foot pressure or the use of a hammer.

U.S. Pat. No. 6,098,292 DEMOLITION TOOL, issued Aug. 8, 2000 to William Harpell discloses a tool having a flat, quadrangular shaped blade with a straight front edge and a parallel back edge, the front edge being tapered to provide a cutting edge. A handle receiving tube extends upwardly and rearwardly from the top of the blade, the tube being centered between the sides of the blade. At least one impact receiving member is on the tool positioned to allow the blade to be hammered in a direction to drive the blade forwardly to have the front edge of the blade cut through material. A groove is formed in the bottom surface of the blade, the groove being unshaped with the base of the groove parallel to the front edge of the blade and located in front of the handle receiving tube. The groove forms a strengthening ridge on the upper surface of the blade. A strengthening strap is fastened to the lower, front portion of the handle receiving tube and extends forwardly on the upper surface of the blade toward the front edge of the blade. Preferably, the front cutting edge of the blade is slotted to allow nail removal with the tool. Specifically, Harpell discusses a prior art practice of hammering a shovel (column 1, lines 18-20).

U.S. Pat. No. 6,983,674 DEVICE AND METHOD FOR DELIVERING AN IMPACT, issued Jan. 10, 2006 to Joseph Rufolo, Jr. discloses an impact device has a handle attached to an impact head. A weight is reciprocatably mounted on a guideway on the impact head. The weight can move along the guideway between a first position and a second position in response to motion of the head. A yielding member such as a spring or elastomeric element can be mounted at the impact head. The weight can recoil against the yielding member in response to motion of the head. The impact head can hit an object in such a manner as to move the weight in a straight line from the first position to the second position. Specifically, Rufolo, Jr. discloses that an impact device may have a shovel edge (claims 1 and 13).

U.S. Pat. No. 2,406,116 ADZ ATTACHMENT FOR HAMMERS, issued Aug. 20, 1946 to Leland M. Van Slyke, shows an adz attachment for a hammer head.

U.S. Pat. No. 5,768,785 for VERSATILE IMPACT TYPE HAND TOOL, issued Jun. 23, 1998 to Ray H. Pessin, shows an improved spade-type hand tool incorporates an easily operated impact member which is slidably received on the upper end of the tool handle for acceleration by gravity to generate an impactive force for increasing the efficiency of the tool for chopping ice, roots, hard soil, etc. Attached to the tool's spade-type blade is an inclined-ramp component that serves (a) to lift, separate, and break up material into which the blade is driven, and (b) to increase the effectiveness of the spade tool when it is used for prying or as a lifting wedge.

U.S. Pat. No. 7,320,490 for IMPACT HANDLE FOR SHOVELS AND RELATED HAND TOOLS, issued Jan. 22, 2008 to Ray James Yakimchuk (see column 4, lines 38-64); United States Published Patent Application No. 2007/0193754 for LINEAR ACTION RECIPROCATING GARDEN HOE, published Aug. 23, 2007 upon application by Carl L. Beckman et al., (see paragraph 12); and United States Published Patent Application 2012/0111587 PERCUSSIVE SHOVEL FOR ROBOTIC APPLICATIONS, published May 10, 2012 upon application by Phillip Chu et al., (see paragraphs 20 and 21) all disclose powered impact tools.

None of the patents and published patent applications, taken singly, or in any combination are seen to teach or suggest the novel digging tool of the present invention.

### SUMMARY OF THE INVENTION

In accordance with the present invention there is provided a digging tool having a short handle and downwardly depending blade that can be placed on the ground. A struck (i.e., force receiving) surface is provided and configured to be struck by a hammer in order to drive the working end (i.e., downwardly depending blade) of the tool into the soil. Once driven into the soil, the user can simply lift up the handle to break the soil, and pull the soil out of the way. The tool may then be moved to the next location and the striking, breaking, pulling, moving sequence of operation may be repeated.

The novel digging tool is particularly useful in locations where there is limited overhead clearance, for example in a crawl space under a house. In such spaces, conventional tools of the prior art are typically raised over a user's head and then swung downward with sufficient force to accomplished a desired digging task. In areas having limited overhead clearance, such prior art tools typically cannot be directed downwards with sufficient force and precision to accomplish efficiently the desired digging task.

The head of the tool is placed on the ground and the head of the tool is hit with a hammer eliminating the swinging of a long handle to create the necessary force to drive the tool into the soil. The hammer's momentum provides the force necessary to drive the tool head into the soil.

The method of operation of the novel tool of the invention provides a precision digging tool where the blade of the tool is placed on the ground at a desired location and the tool is then hit with a hammer. The result is much greater precision than that generally achieved when the digging is accomplished with a prior art tool in which a user is swinging the tool handle over his or her head and trying to hit an exact location on the ground.

It is another object of the invention to provide a tool for digging while in a prone, kneeling, or squating position.

It is, therefore, an object of the invention to provide a short handle digging tool for use in spaces with limited vertical clearance or where precision digging is desired.

It is another object of the invention to provide a short handle digging tool having a struck surface for receiving an impact force from a hammer or the like.

It is an additional object of the invention to provide a short handle digging tool wherein a struck surface is aligned with a downwardly depending blade.

It is yet another object of the invention to provide a short handle digging tool wherein the blade may be positioned accurately on the ground prior to striking to allow high precision digging.

It is a further object of the invention to provide a short handle digging tool wherein a wood, fiberglass, or steel handle is affixed to a head thereof.

It is a still further object of the invention to provide a short handle digging tool whose head is formed from metal such as forged carbon steel, aluminum, or titanium or other rigid material.

It is yet another object of the invention to provide a short handle digging tool that may be provided with blades having a variety of different shapes and functions.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIGS. 1A and 1B are side elevational and front elevational, respectively, schematic view of a typical adze hammer of the prior art;

FIGS. 2A and 2B are side elevational and front elevational, respectively, schematic view of a typical pick mattock of the prior art;

FIGS. 3A and 3B are side elevational and front elevational, respectively, schematic view of a first embodiment of a digging tool in accordance with the present invention;

FIGS. 4A and 4B are side elevational and front elevational, respectively, schematic view of an alternate embodiment of a digging tool in accordance with the present invention; and

FIGS. 5A and 5B are side elevational and front elevational, respectively, schematic views of a third alternate embodiment of a digging tool in accordance with the invention.

### DETAILED DESCRIPTION OF THE PREFERRED EMBODIMENT

The present invention provides a novel tool that combines either an adze or grub hoe-like blade, or forked shaped blades with an aligned hitting surface to allow a hammer or similar object to drive the blade into hard soil. The novel tool is particularly useful in tight spaces where there is insufficient vertical clearance to swing a conventional grub hoe, adze, pick mattock, or other similar tool to break and move hardened ground.

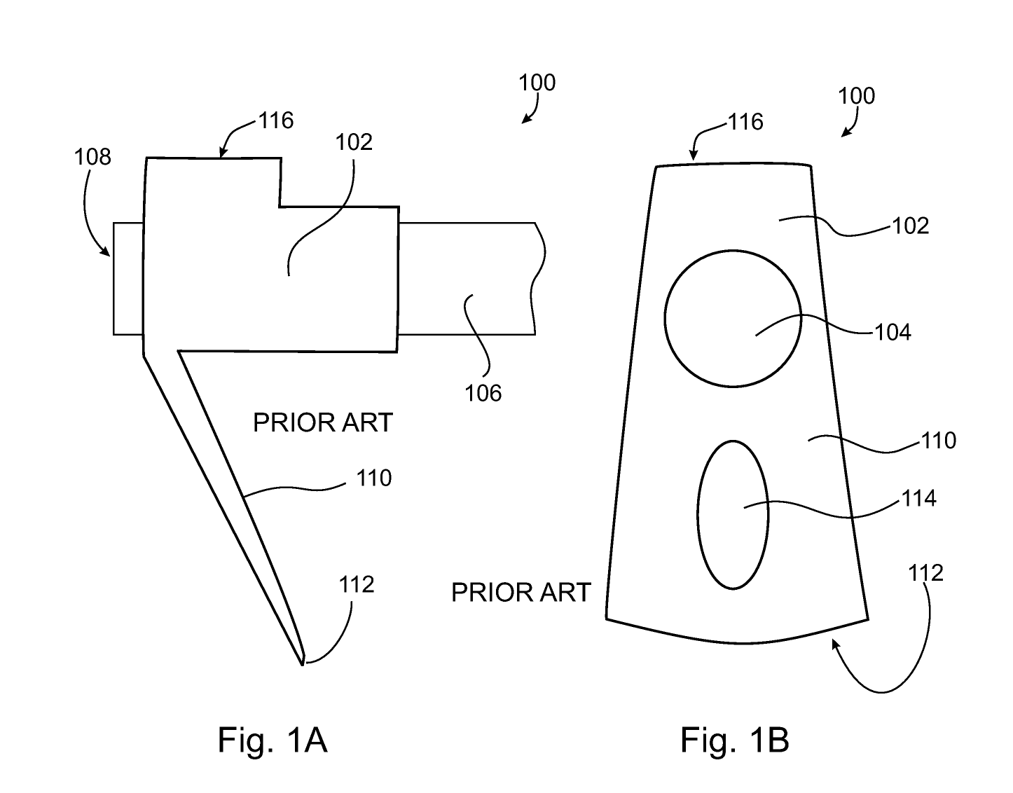

Referring first to FIGS. 1A and 1B, there are shown side elevational and front elevational schematic views, respectively, of a simple adze hammer of the prior art, generally at reference number 100.

Adze hammer 100 has a head 102, typically formed from forged carbon steel, aluminum, titanium, or other similar metal. An opening 104 is formed centrally in head 102. Opening 104 receives and retains an elongated handle 106. Handle 106 is typically fastened to head 102 by, for example, soaking region of handle 106 proximate end 108 of handle 106 in water or another solution prior to its forced insertion into opening 104. Once handle 106 dries, it expands to tightly grip the sides of opening 104, thereby fastening head 102 to handle 106. Alternately, handle 106 may have one or more wedges, none shown, driven into an end 108 of handle 106. These wedges cause proximal end of handle 106 to be mechanically expanded to tightly grip the sides of opening 104. It will be recognized that other devices and/or techniques for retaining handle 106 in head 102 are well know by those of skill in the art.

A curved, downward depending blade 110 is affixed to head 102. Blade 110 typically has a sharpened portion 112 at the distal end thereof.

An optional opening 114 may be formed in blade 110, typically to reduce the weight of adze hammer 100.

A hammer head 116 is formed on an upper region of head 102. Hammer head 116 is intended to function as a conventional hammer and is not generally used to receive an impact force.

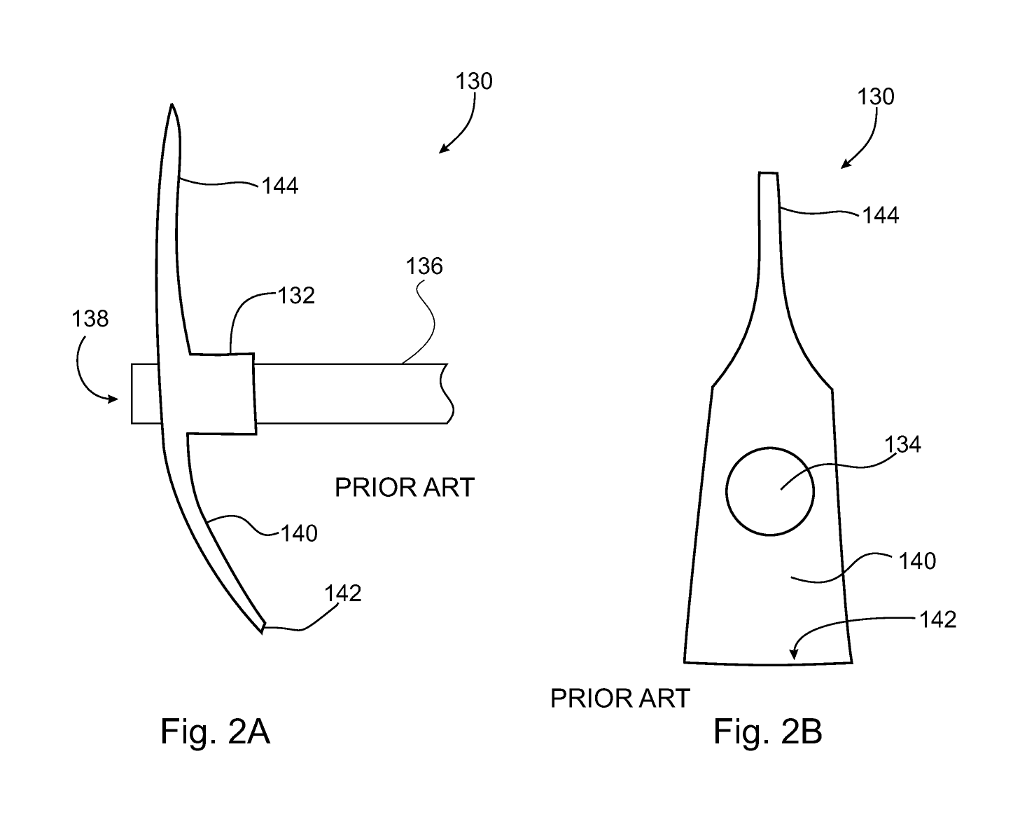

Referring now also to FIGS. 2A and 2B there is shown side elevational and a front elevational schematic views, respectively, of a pick mattock, another tool of the prior art, generally at 130.

Pick mattock 130 has a head 132 having a hole 134 therethrough for retaining the handle 136. A lower blade 140 is downwardly directed from head 132. An upper blade, typically a pick blade 144 is directed upwardly from head 132.

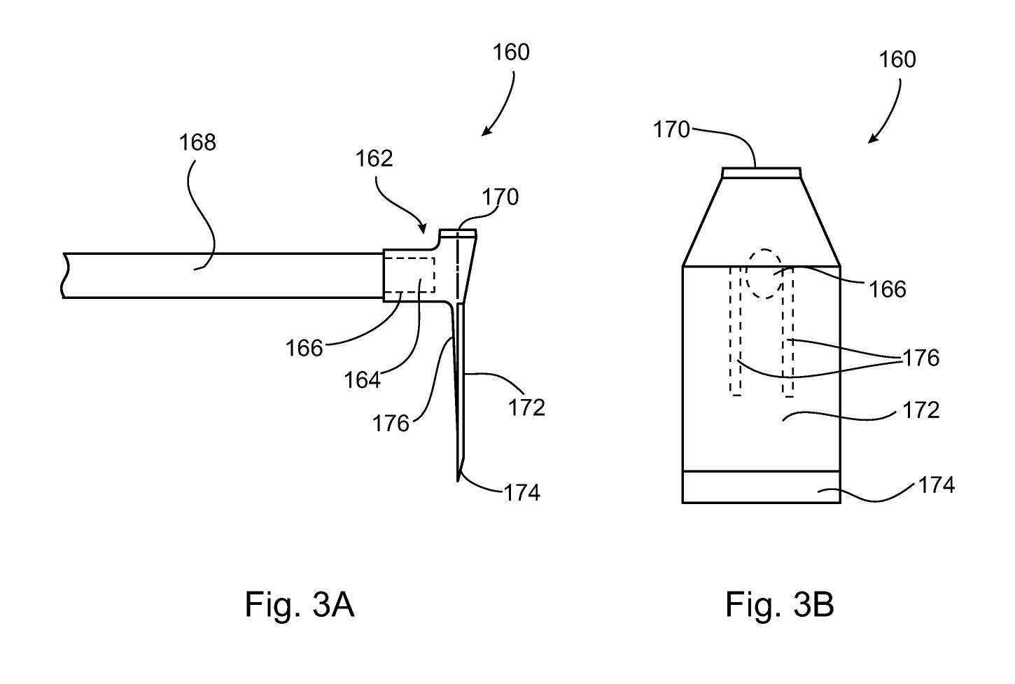

Referring now also to FIGS. 3A and 3B, there are shown side elevational and front elevational schematic views, respectively of a novel tool in accordance with the invention, generally at reference number 160.

Tool 160 has a metal head 162, typically formed from forged carbon steel. It will be recognized by those of skill in the art that other metals may be selected to meet a particular operating circumstance or environment. Consequently, the invention is not limited to forged steel chosen for purposes of disclosure, rather the invention is intended to cover all suitable alternate materials.

Head 162 has a central portion 164 having a rearward facing hollow opening 166 therein. Hollow opening 166 is adapted to receive and retain a handle 168. Handle 168 may typically be formed from wood, fiberglass, or steel. However, it will be recognized by those of skill in the art that handles formed from alternate materials or composite materials may be substituted therefor.

Handle 168 typically has an oval cross section, not shown. However, handle 168 might have other cross sectional shapes, for example square, especially at a proximal end where it enters head 162. Rearward facing hollow opening 166 will, of course, be sized and configured to accommodate the proximal end of handle 168.

Handle 168 may be provided in any suitable length. The handle may be fixed or removable. However, for the application of novel tool 160 for use in spaces having limited overhead clearance, it is anticipated that a handle might be approximately 18 inches in length.

A top portion 170 of head 162 serves as a force receiving surface. Force receiving portion 170 may be specially treated to prevent metal fatigue, splaying, or any other degradation caused by repeated striking by a hammer or similar object. Such treatments are believed to be well known to those skilled in the field of metallurgy and, consequently, these treatments are neither further described nor discussed herein.

Force receiving top portion 170 is directly aligned above a downwardly depending blade 172 extending from a lower edge of head 162. Blade 172 terminates at a tapered lower edge 174. This alignment is such that a centerline passing through said force receiving surface 170 extends through the central portion 164 and extends into and through a central portion of the downwardly directed blade 172.

A pair of narrow stiffeners 176 is disposed on a back surface of blade 172 extending partially down blade 172 parallel to one another and substantially perpendicular to handle 168.

It is anticipated that tool 160 in accordance with the invention may be provided having a downward depending blade having the shape either of a grub hoe, a mattock, tines, or a pick.

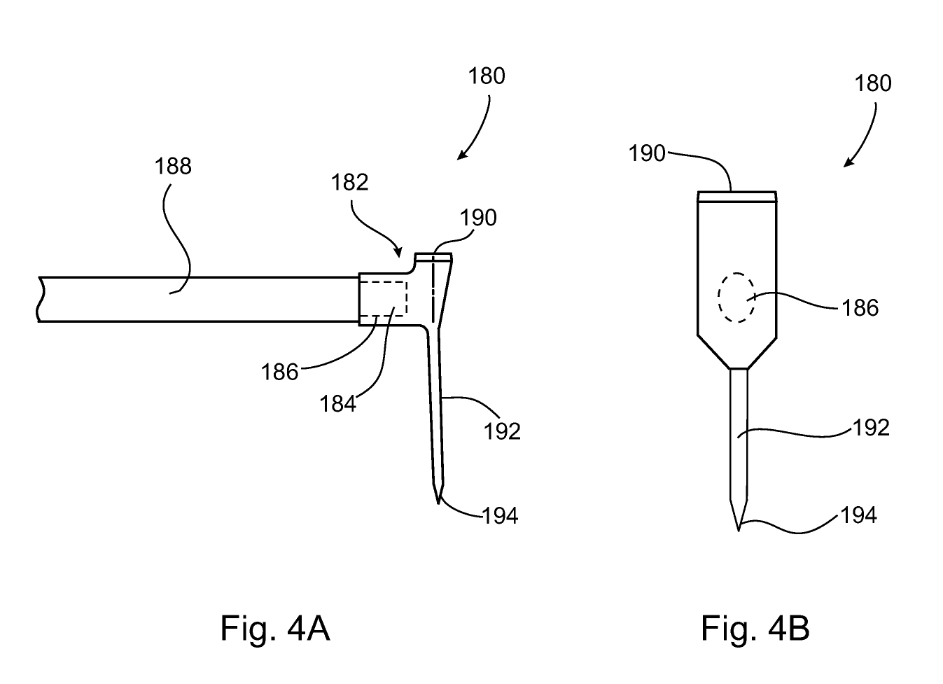

Referring now also to FIGS. 4A and 4B, there are shown front elevational and side elevational, respectively, schematic views of an alternate embodiment of the tool 180 in accordance with the invention.

Tool 180 has a head 182 having a central portion 184. Central portion 184 has a rearward facing hollow opening 186 sized and configured to receive and retain a proximal end of a handle 188.

A top portion 190 of head 182 serves as a force receiving surface. Force receiving portion 190 may be specially treated to prevent metal fatigue, splaying, or any other degradation caused by repeated striking by a hammer or similar object. Such treatments are believed to be well known to those skilled in the field of metallurgy and, consequently, these treatments are neither further described nor discussed herein.

Force receiving top portion 190 is directly aligned above a downwardly depending blade 192 extending from a lower edge of head 182. Blade 192, unlike the wide blade 172 of the embodiment of FIGS. 3A and 3B, is a pick style blade. Blade 192 terminates at a tapered point 194.

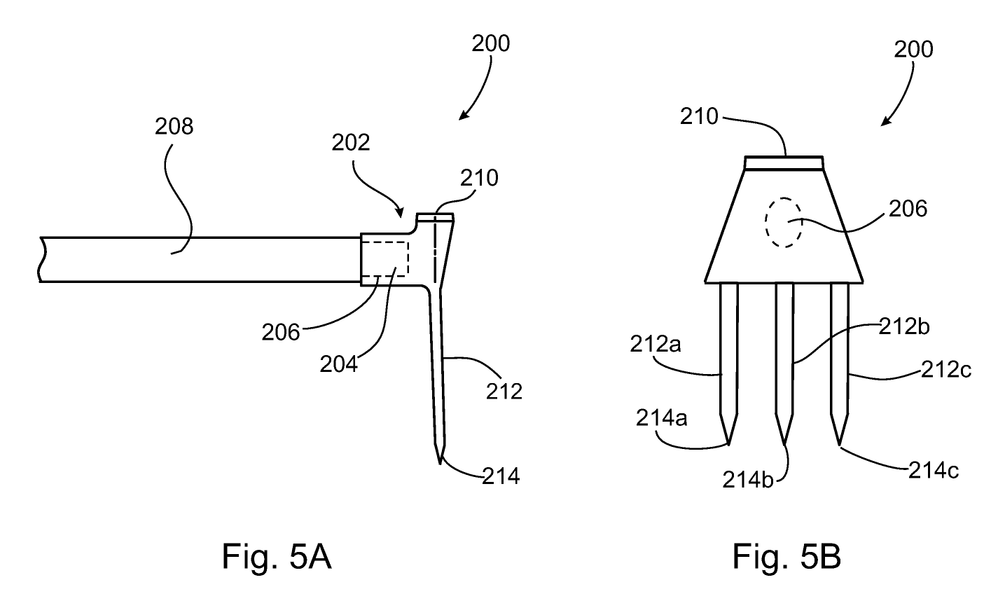

Referring now also to FIGS. 5A and 5B there are shown front elevational and side elevational, respectively, schematic views of another alternate embodiment of the tools 160, 180 in accordance with the invention, generally at reference number 200.

Tool 200 has a head 202 having a central portion 204. Central portion 204 has a rearward facing hollow opening 206 sized and configured to receive and retain a proximal end of a handle 208.

A top portion 210 of head 202 serves as a force receiving surface. Force receiving portion 210 may be specially treated to prevent metal fatigue, splaying, or any other degradation caused by repeated striking by a hammer or similar object. Such treatments are believed to be well known to those skilled in the field of metallurgy and, consequently, these treatments are neither further described nor discussed herein.

Force receiving top portion 210 is directly aligned above a central one 212b of multiple downwardly depending blades 212a, 212b, 212c extending from a lower edge of head 202. Downwardly depending blades 212a, 212b, 212c, unlike the wide blade 172 of the embodiment of FIGS. 3A and 3B, is a fork tyne style blade. Blades 212a, 212b, 212c each terminate at a respective tapered point 214, 214b, 214c

Tools 160, 180, and 200 are particularly useful for breaking up ground in confined spaces where vertical clearance precludes swinging tools 160, 180, and 200 in a conventional manner. Instead, tools 160, 180, 200 are first located on a spot that a user wishes to break. When in place, a hammer, not shown and forming no part of the invention, is used to strike force receiving surfaces 170, 190, 210 respectively. One hammer found suitable for use with tools 160, 180 is a well-known 4 lb engineer's hammer. It will be recognized that any hammer or other implement capable of generating sufficient force or virbration may be used to strike force receiving surfaces 170, 190, 210. It will be recognized by those of skill in the art that numerous different styles, sizes, and weights of hammers or other implements may be used.

Novel tool 160 may be further used as a digging tool, operating like a well known “grub hoe” to excavate dirt once the ground is broken up by tools 160, 180, 200 as described above. Once blade 172 or blades 192 or clades 212a, 212b, 212c are driven into the ground by a force applied to the respective force receiving (i.e., striking) surface 170, 190, 210, lifting the handle 168, 188, 208 breaks the soil loose, typically from a depth of four to six inches. Blade 172 of tool 160 may then pull the loosened soil out of the way. Once the desired amount of soil is pulled out of the way, blades 172, 192, 212a, 212b, 212c are repositioned and the process is restarted.

By manually placing blade 172, 192, or 212a, 212b, 212c precisely where the user intends to break the soil, the novel tools 160, 180, 200 overcome another difficulty of using a grub hoe, adze hammer, pick mattock, or other similar tool of the prior art. When using one of such tools of the prior art, the tool is typically raised high over the user's head and then forcefully brought down onto the ground. Where the blade impacts the earth is somewhat fortuitous. By placing blade 172, 192, 212a, 212b, 212c precisely where the user intends, precision digging, far better than what is possible with tools of the prior art, may be achieved.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A digging tool, comprising:
a) a head having a central portion including a rearward facing hollow opening adapted and configured to receive a handle therein;
b) an elongated handle having a proximal end, said proximal end being retained in said rearward facing hollow opening;
c) a force receiving surface disposed at a top surface of said central portion; and
d) at least one downwardly directed blade aligned with said force receiving surface and a disposed blade on a bottom surface of said central portion.

2. The digging tool as recited in claim 1, wherein said downwardly depending blade has a shape chosen from the group: a grub hoe blade, an adze hammer blade, a mattock blade, at least two forked shaped blade, and a pick blade.

3. The digging tool as recited in claim 1, wherein said head is formed from at least one metal selected from the group: forged carbon steel, aluminum, titanium, and other similar metal.

4. The digging tool as recited in claim 1, wherein said force receiving surface comprises a treated force receiving surface adapted to be struck with a hammer.

5. The digging tool as recited in claim 4, wherein a center of said force receiving surface is substantially aligned with a center of said downwardly directed blade.

6. The digging tool as recited in claim 1, wherein said handle has a length of approximately 18 inches.
